(19) United States
(12) Patent Application Publication
(10) Pub. No.: US 2008/0319888 A1
(43) Pub. Date: Dec. 25, 2008

(54) Allocation of residual value risk

(76) Inventors: Raimund Ohnemus, Munchen (DE); Klaus Saal, Munchen (DE); Markus Erban, Munchen (DE)

Correspondence Address: CROWELL & MORING LLP;INTELLECTUAL PROPERTY GROUP, P.O. BOX 14300, WASHINGTON, DC, 20044-4300, US

(21) Appl. No.: 11/823,004

(22) Filed: Jun. 25, 2007

(51) Int. Cl. G06Q 40/00

(52) U.S. Cl. 705/35

(57) ABSTRACT

Residual value risk may be allocated for a leased vehicle between a dealer organization and a manufacturer group, where the manufacturing group may include both a financing institution and a sales organization. In one embodiment, residual value risk may be allocated by first calculating a difference between a residual value for the leased vehicle and the vehicle's actual value. This difference may then be allocated between the manufacturer group and the dealer organization according to some predetermined ratio which represents a corresponding financial obligation or benefit, depending on if the difference is positive or negative.

### FIELD OF THE INVENTION

The present invention relates in general to vehicle leasing, and more particularly to allocation of the residual value risk associated with vehicle leasing.

### BACKGROUND OF THE INVENTION

Vehicle leasing has increasingly become the preferred approach for new vehicle financing. Vehicles which are leased remain the property of the financing company, while the consumer enjoys the rights associated with operating the vehicle over some predetermined period of time. For example, FIG. 1 depicts a typical vehicle lease transaction 100 involving a consumer 110, a dealer organization 120 and a manufacturer group 130. The manufacturer group comprises a financing institution 140 and a sales organization 150. In the typical course, the sales organization wholesales vehicles to the dealer organizations through transaction 160. Consumer 110 interacts with the dealer organization 120 to shop for, test drive and eventually lease a vehicle.

The actual leasing transaction, however, involves several sub-transactions between the dealer organization 120, the financing institute 130 and the consumer 140. In particular, the subject vehicle is technically sold by the dealer organization 120 to the financing institute 140, and not the consumer 110, through transaction 170. The financing institution 140 then enters into a leasing agreement 180 with the consumer 110, which includes terms such as purchase price, residual value, lease term, etc. In the leasing context, the residual value is the resale value of the subject vehicle at the point in time when the lease agreement expires, otherwise referred to as the lease's maturity date. The residual value is typically represented as a percentage of the vehicle's manufacturer's suggested retail price (MSRP).

Transaction 170 between the dealer organization 120 and the financing institute 140 may also include some of the agreed terms that are to be included in the lease agreement 180 with the consumer 110. Once the consumer 110 has executed the lease agreement 170, the dealer organization 120 will deliver the vehicle to the consumer 110, shown as transaction 190 in FIG. 1.

Many consumers prefer the above-described vehicle leasing approach to the vehicle purchase approach due to the fact it insulates them from fluctuations in the value of the vehicle at the end of the lease term, otherwise known as the vehicle's resale or residual value. That is, the consumer is given the option of purchasing the vehicle outright at the end of the lease term, or simply turning it back into the dealer organization without any further financial obligations.

Vehicle financing companies often use third parties, such as Automotive Lease Guide, Inc., to determine the residual value, which is one of the primary values used to determine the consumer's monthly payments, and hence, the amount collected during the lease term. In essence, the higher the vehicle's residual value, the lower the consumer's monthly payments will be during the lease term. This is because the financing company can expect to re-sell the vehicle at lease maturity for a relatively higher amount, which means it does not need to charge as much on a monthly basis to eventually collect the total purchase price. However, if the vehicle's residual value is set to be higher than its actual value, a net loss will result since the value of the vehicle at lease maturity, added to the amount collected from the consumer during the lease term, will be less than the original purchase price of the vehicle. The possibility of this loss is known as the ‘residual value risk.’

While many factors go into determining the residual value (e.g., lease term, interest rates, expected mileage, vehicle brand, etc.), the fact of the matter is that the probability of picking the true residual value three or four years in advance is quite low. That means the majority of the time the residual value will be either overestimated or underestimated. If the residual value is overestimated, the purchase price of the vehicle at lease maturity will be higher than the actual value of the vehicle and the consumer will simply turn the vehicle back into the dealer organization. The vehicle will then be sold for its actual value, resulting in a net loss. If, on the other hand, the residual value is underestimated the purchase price for of the vehicle for the consumer at lease maturity will be lower than the actual value, meaning that a rational consumer will opt to purchase the vehicle at the below-market amount. Thus, there is a considerable amount of downside risk associated with incorrectly setting the residual value, but little chance of reaping the benefits from residual values which are far above actual value. Accordingly, there is a need in the art for an improved leasing allocation that more equitably distributes the residual value risk between the various interested parties.

### BRIEF SUMMARY OF THE INVENTION

Disclosed and claimed herein are methods for allocating residual value risk for a vehicle leased to a consumer. In one embodiment, a method includes setting a residual value for the vehicle to be applicable at a predetermined maturity date, determining an actual value for the vehicle at the predetermined maturity date, and calculating a difference between the residual value and the actual value. The method further includes allocating a first portion of the difference to a dealer organization, and then allocating a second portion of the difference to a manufacturer group, where the manufacturer group includes a financing institution which financed the vehicle for the consumer, and a sales organization which sold the vehicle to the dealer organization.

Other aspects, features, and techniques of the invention will be apparent to one skilled in the relevant art in view of the following detailed description of the invention.

### BRIEF DESCRIPTION OF THE DRAWINGS

The features, objects, and advantages of the present invention will become more apparent from the detailed description set forth below when taken in conjunction with the drawings in which like reference characters identify correspondingly throughout and wherein:

FIG. 1 depicts a typical vehicle leasing transaction;

FIG. 2 is one embodiment of a process for carrying out one or more aspects of the invention;

FIGS. 3A-3B depict embodiments of how residual value risk may be allocated according to one or more embodiments of the invention;

FIGS. 4A-4C depict specific examples of residual value risk allocations in accordance with the embodiment of FIG. 3A; and

FIG. 5 depicts another embodiment of how residual value risk may be allocated.

### DETAILED DESCRIPTION OF EXEMPLARY EMBODIMENTS

The present disclosure relates generally to allocating residual value risk for a leased vehicle. In certain embodiments, a residual value for a vehicle is first set. This value may be based on the lease maturity date for the subject vehicle, and may be provided by a third party. Thereafter, the vehicle's actual value may be determined based, for example, on a resale price of the vehicle following the lease maturity date. In one embodiment, the dealer organization which took back the vehicle following the lease term may resell the vehicle in an auction-type transaction to determine this resale price, or actual value.

A difference between the aforementioned residual value and actual value may then be determined, and in one embodiment may be represented as a percentage of the vehicle's MSRP. This difference, or gap, may then be allocated between the manufacturer group and a dealer organization, where the manufacturer group may include a financing institution which financed the vehicle for the consumer, and a sales organization which sold the vehicle to the dealer organization. In certain embodiments, allocation of this difference may including dividing the different amount according to a predetermined ratio and allocating a corresponding financial obligation (in the event the difference is negative) or financial benefit (in the event the difference is positive) to each of the aforementioned parties. As will be described in detail below, the specific allocation may vary between the dealer organization, financing institution and sales organization, and may even vary as a function of how large the difference is.

As used herein, the terms “a” or “an” shall mean one or more than one. The term “plurality” shall mean two or more than two. The term “another” is defined as a second or more. The terms “including” and/or “having” are open ended (e.g., comprising). The term “or” as used herein is to be interpreted as inclusive or meaning any one or any combination. Therefore, “A, B or C” means any of the following: A; B; C; A and B; A and C; B and C; A, B and C. An exception to this definition will occur only when a combination of elements, functions, steps or acts are in some way inherently mutually exclusive. Reference throughout this document to “one embodiment”, “certain embodiments”, “an embodiment” or similar term means that a particular feature, structure, or characteristic described in connection with the embodiment is included in at least one embodiment of the present invention. Thus, the appearances of such phrases in various places throughout this specification are not necessarily all referring to the same embodiment. Furthermore, the particular features, structures, or characteristics may be combined in any suitable manner on one or more embodiments without limitation.

In accordance with the practices of persons skilled in the art of computer programming, the invention is described below with reference to operations that are performed by a computer system or a like electronic system. Such operations are sometimes referred to as being computer-executed. It will be appreciated that operations that are symbolically represented include the manipulation by a processor, such as a central processing unit, of electrical signals representing data bits and the maintenance of data bits at memory locations, such as in system memory, as well as other processing of signals. The memory locations where data bits are maintained are physical locations that have particular electrical, magnetic, optical, or organic properties corresponding to the data bits.

When implemented in software, the elements of the invention are essentially the code segments to perform the necessary tasks. The code segments can be stored in a processor readable medium, which may include any medium that can store or transfer information. Examples of the processor readable mediums include an electronic circuit, a semiconductor memory device, a read-only memory (ROM), a flash memory or other non-volatile memory, a floppy diskette, a CD-ROM, an optical disk, a hard disk, a fiber optic medium, a radio frequency (RF) link, etc.

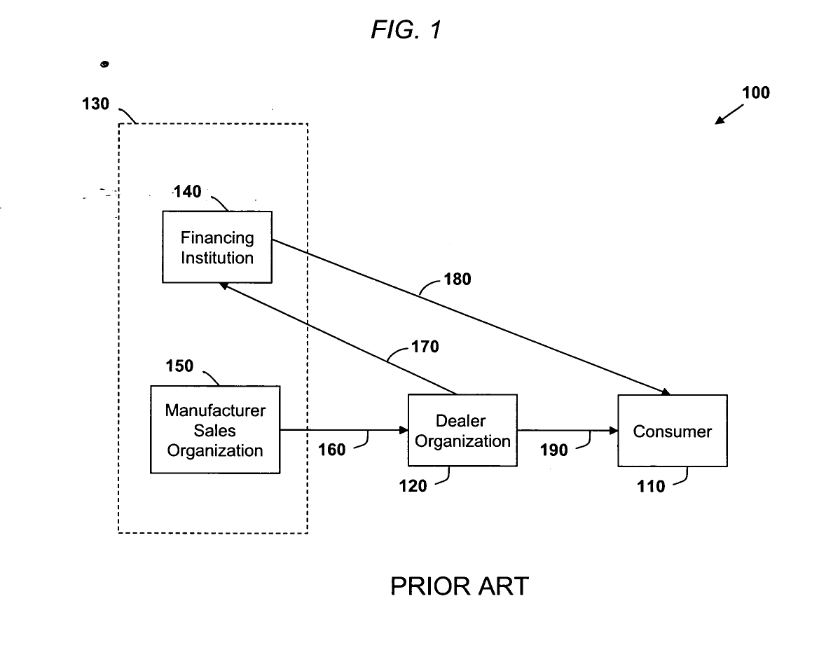

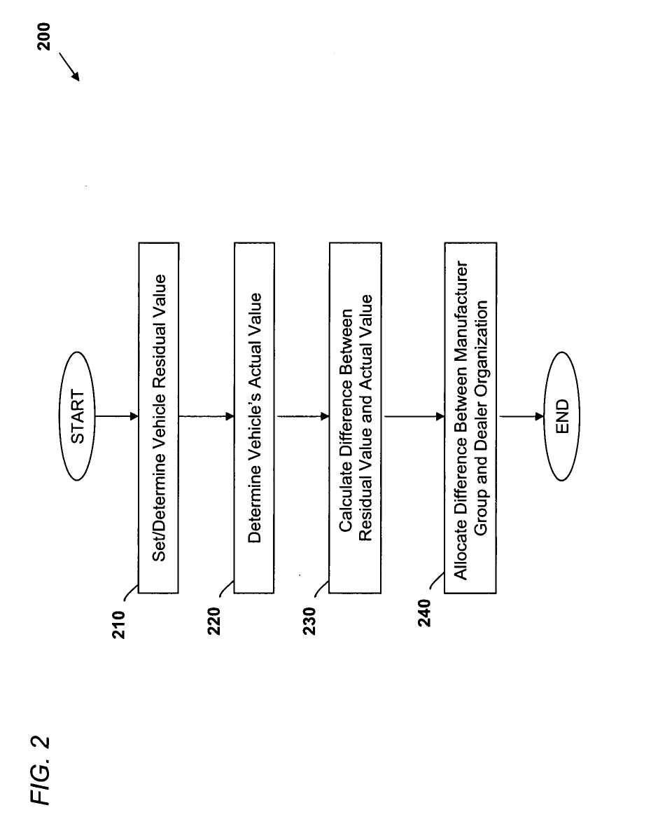

Referring now to the figures, FIG. 2 depicts a process 200 for allocating residual value risk for a vehicle in accordance with one embodiment of the invention. Process 200 begins at block 210 where the residual value for a vehicle is set. In one embodiment, this value may be based on the lease maturity date for the subject vehicle, and may be provided by a third party. As previously mentioned, the residual value is the resale value of the subject vehicle at the point in time when the lease agreement expires, otherwise referred to as the lease's maturity date. The residual value is typically represented as a percentage of the vehicle's MSRP, but may be represented as a fixed dollar amount, percentage of sale price, etc. The value may be set at block 210 by incorporating it, for example, as a material term to a lease agreement with a consumer (e.g., consumer 110 of FIG. 1) for the subject vehicle.

In another embodiment, the operation of block 210 may comprise determining the vehicle's residual value. To that end, the operation of block 210 may be performed by referencing the previously-set residual value from the underlying lease agreement.

In any case, once the residual value is known, process 200 may continue to block 220 where the vehicle's actual value may be determined. In one embodiment the vehicle's actual value may be based on a resale price of the vehicle following the lease maturity date. In one embodiment, the dealer organization (e.g., dealer organization 120 of FIG. 1) which took back the vehicle following the lease term may resell the vehicle in an auction-type transaction. The amount that the dealer organization was able to fetch for the vehicle may be used as the vehicle's actual value for purposes of process 200. Alternatively, the vehicle's actual value may be based on a third-party estimation (e.g., Kelley Blue Book™).

Continuing to refer to FIG. 2, process 200 continues to block 230 where a difference between the residual value from block 210 and the actual value from block 220 may be calculated. In one embodiment, this difference, which may be either positive or negative, may be represented as a percentage of the vehicle's MSRP.

Process 200 may then continue to block 240 where the difference from block 240 may be allocate between the manufacturer group (e.g., manufacturer group 130 of FIG. 1) and a dealer organization (e.g., dealer organization 120 of FIG. 1), where the manufacturer group includes a financing institution (e.g., financial institution 140 of FIG. 1) which financed the vehicle for the consumer, and a sales organization (e.g., sales organization 150 of FIG. 1) which sold the vehicle to the dealer organization. In one embodiment, the difference of block 230 may be divided into a first portion and a second portion. The first portion may then be allocated to the dealer organization, while the second portion may be allocated to the manufacturer group. Moreover, in one embodiment the first portion and second portion may be about equal. In this fashion, the residual value risk associated with the vehicle may be allocated across all the interested parties.

In addition, and as will be explained in more detail below, the allocating of the first portion and second portion may be done only up to a predetermined amount. Any difference from block 230 which exceeds this predetermined amount may be allocating as a third portion to either of the dealer organization or manufacturer group. Additional embodiments for the allocation operation of block 240 are described below with reference to the following figures.

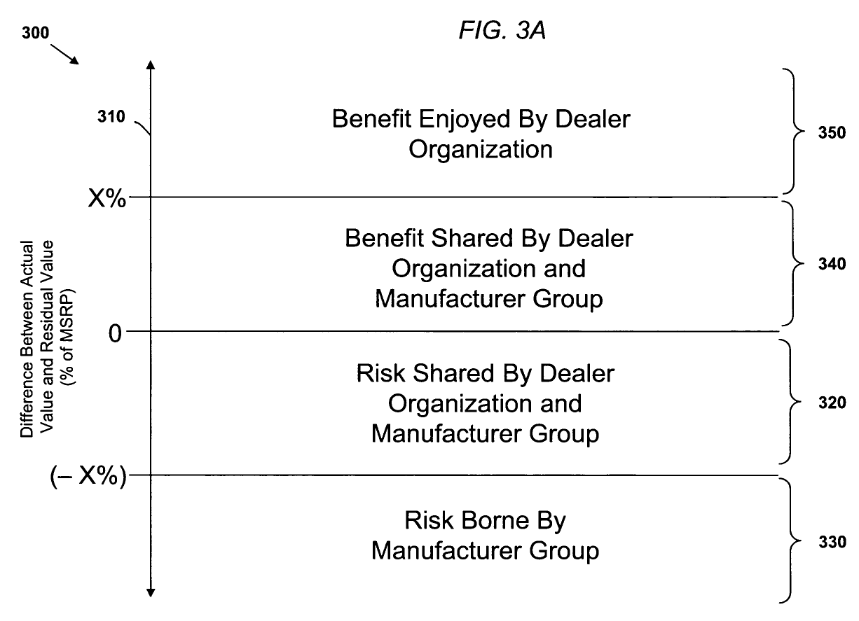

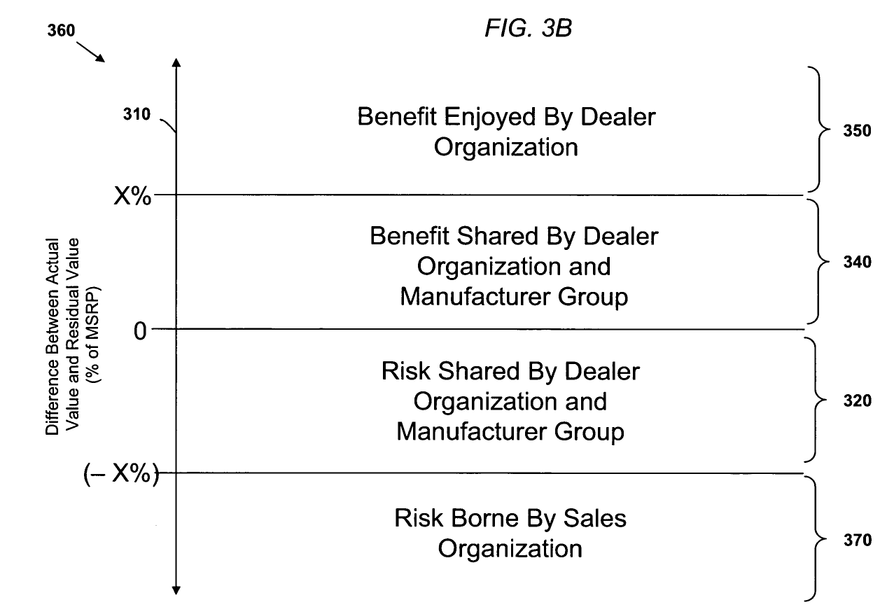

FIG. 3A depicts a graph 300 of how residual value risk may be allocated amongst a dealer organization (e.g., dealer organization 120 of FIG. 1) and a manufacturer group (e.g., manufacturer group 130 of FIG. 1), where the manufacturer group may include both a financing institution (e.g., financing institution 140 of FIG. 1) as well as a sales organization (e.g., sales organization 150 of FIG. 1).

FIG. 3A plots along axis 310 the difference, or gap, between the vehicle's actual value against the vehicle's residual value, expressed as a percentage of the vehicle's MSRP. In one embodiment, this percentage represents the amount calculated at block 230 of FIG. 2. It should be appreciated, however, that this amount may be represented in a myriad of other forms which equally reflect the residual value risk/benefit which is to be allocated.

When the value of axis 310 is between 0 and −X %, the vehicle is in gap 320 and the risk (or financial burden) may be shared between the dealer organization and the manufacturer group in accordance with one embodiment of the invention. While in one embodiment this may represent an equal 50%/50% sharing arrangement of gap 320 between the dealer organization and the manufacturer group, in another embodiments there may dissimilarly weighted or skewed sharing. In addition, and as previously mentioned, there may further be a sharing among the manufacturing group entities (i.e., the financing institution and the sales organization) for the gap 320. To that end, and by way of a non-limiting example, in one embodiment ratio of risk allocation between the dealer organization, financing institution and sales organization may be 3:2:1.

Continuing to refer to FIG. 3A, when the value of axis 310 is lower than −X %, the risk (or financial burden) associated with gap 330 is borne exclusively by the manufacturer group, in the embodiment of FIG. 3A. In this fashion, the first X % of the risk may be shared between the dealer organization and the manufacturing group, while additional risk between X % is absorbed by the manufacturer group.

When, however, the value of axis 310 is between 0% and X %, the benefit (or financial gain) associated with gap 340 may be correspondingly shared between the dealer organization and the manufacturer group in accordance with one embodiment of the invention. As with gap 320, the sharing of gap 340 may represent an equal 50%/50% sharing arrangement between the dealer organization and the manufacturer group, although in another embodiments there may be a dissimilarly weighted or skewed sharing. Also, there may equally be a further sharing among the manufacturing group entities (i.e., the financing institution and the sales organization) for the gap 340, as described above with reference to gap 320.

Finally, in the less likely event that the value of axis 310 is higher than X %, the benefit (or financial gain) associated with gap 350 is enjoyed exclusively by the dealer organization, according to the embodiment of FIG. 3A. This scenario is less likely since, as previously mentioned, a rational consumer will likely opt to purchase the vehicle at the below-market amount rather than simply turning it back in to the dealer organization.

While the value of X along axis 310 may be any value, in one embodiment it is equal to 6, such that gap 320 corresponds to a negative difference (or loss) of between 0% and −6%, gap 330 corresponds to a negative difference (or loss) of greater than −6%, gap 340 corresponds to a positive difference (or gain) of between 0% and 6%, and finally gap 350 corresponds to a positive difference (or gain) of greater than 6%.

Referring now to FIG. 3B, depicted is another embodiment of a graph 360 of how residual value risk may be allocated amongst a dealer organization and a manufacturer group, according to another embodiment of the invention. In particular, graph 360 is similar to graph 300 except with respect to the allocation of risk resulting when the value of axis 310 is lower than −X %. In this case, the risk (or financial burden) associated with gap 370 is to be borne exclusively by the sales organization. While this is one variation on the risk allocation graph of FIG. 3A, it should equally be appreciated that numerous other variations would be consistent with the principles of the invention and within the scope of this disclosure. That is, it should be appreciated that many different embodiments of the allocations described in FIG. 3A-3B would similarly function to properly incentivize the various parties involved in the leasing transaction to not only obtain a good market value for the vehicle at lease maturity, but also to ensure that the residual value set at contract time is as accurate as possible.

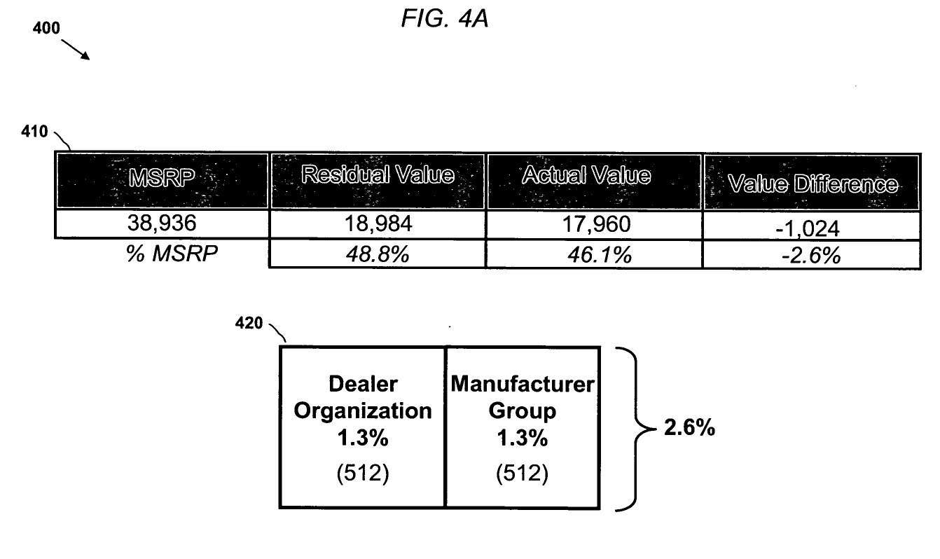

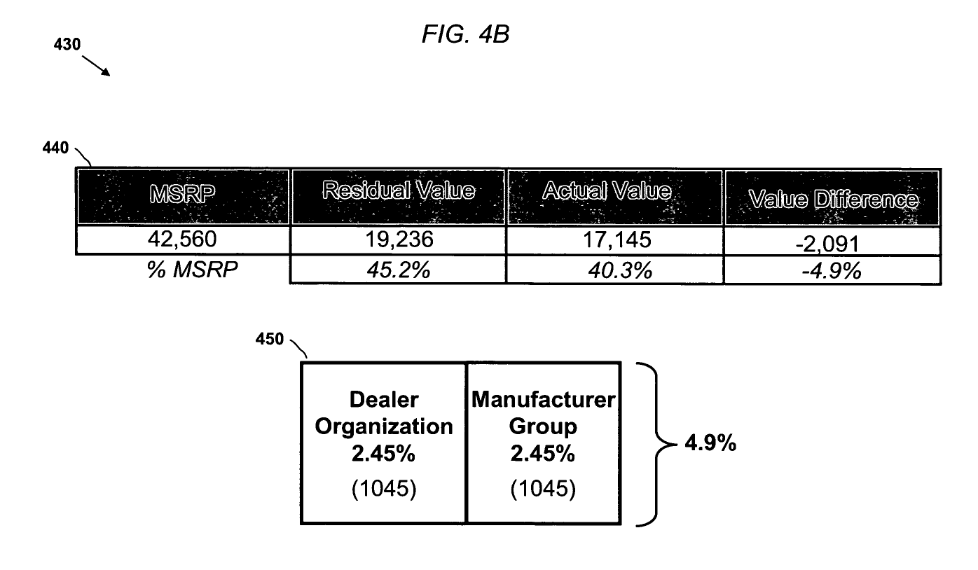

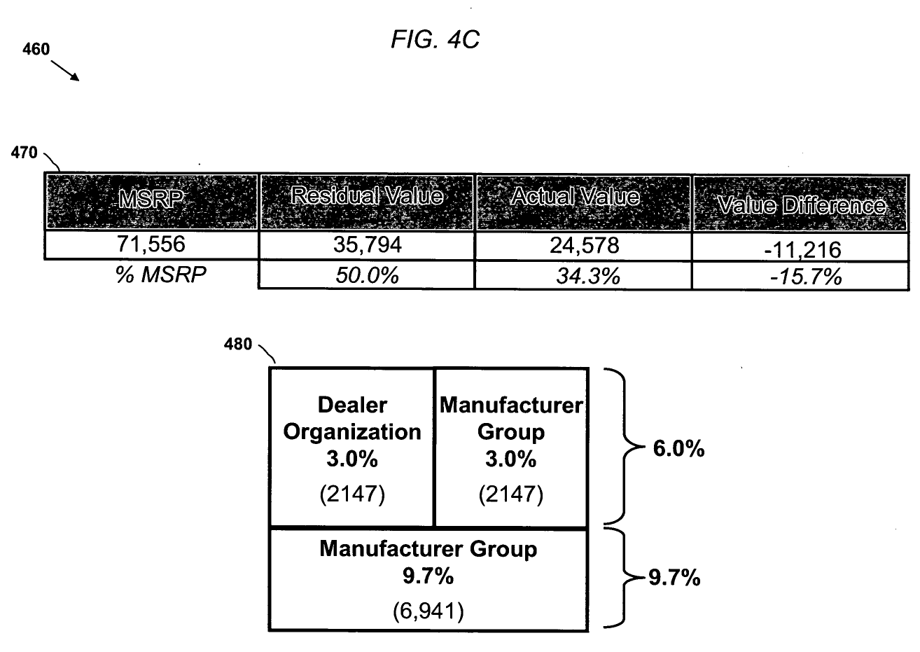

Referring now to FIGS. 4A-4C, depicted are various examples of how residual value risk may be allocated in accordance with the approach of FIG. 3A when X is equal to 6. In particular, example 400 of FIG. 4A depicts a table 410 of the subject vehicle's MSRP, residual value, actual value and the resulting difference or gap. Thus, the difference is equal to −2.6% which would fall squarely in gap 320 of FIG. 3A, thereby requiring the entire financial burden to be shared between the dealer organization and the manufacturer group. In the embodiment where such sharing is to be in equal proportions, graphic 420 depicts how the equal sharing of the 2.6% loss may be allocated such that each of the dealer organization and manufacturing group bears only a 1.3% financial burden.

Similarly, example 320 of FIG. 4B includes a table 440 showing the MSRP, residual value, actual value and resulting difference for a different vehicle. In this example 430, the difference is equal to −4.9% which again falls within in gap 320 of FIG. 3A where the entire difference is to be shared between the dealer organization and the manufacturer group. Assuming that the sharing is to be in equal proportions, graphic 450 depicts how the equal sharing of the 4.9% loss may be allocated such that each of the dealer organization and manufacturing group bears only a 2.45% financial burden.

FIG. 4C depicts yet another example 460 of how residual value risk may be allocated in accordance with the approach of FIG. 3A when X is equal to 6. In particular, the difference between the residual value and actual value in example 460 is −15.7% as shown in table 470, which implicates both gap 320 and gap 330 of FIG. 3A. That is, for the first 6% (since X=6), the burden is shared (e.g., equally) between the dealer organization and manufacturing group. However, beyond that the losses fall within gap 330 where the manufacturer group is to bear the financial burden. To that end, graphic 480 illustrates how the first 6% is shared in equal proportions, but how additional loses are borne by entirely by the manufacturing group.

While not explicitly noted in FIGS. 4A-4C, it should further be appreciated that additional sharing of risk/benefit may be implemented within the manufacturing group such that there is a sharing of the risk/benefit between the financial institution and sales organization share. This internal sharing may be 1:1, 2:1, 1:2, or any other ratio.

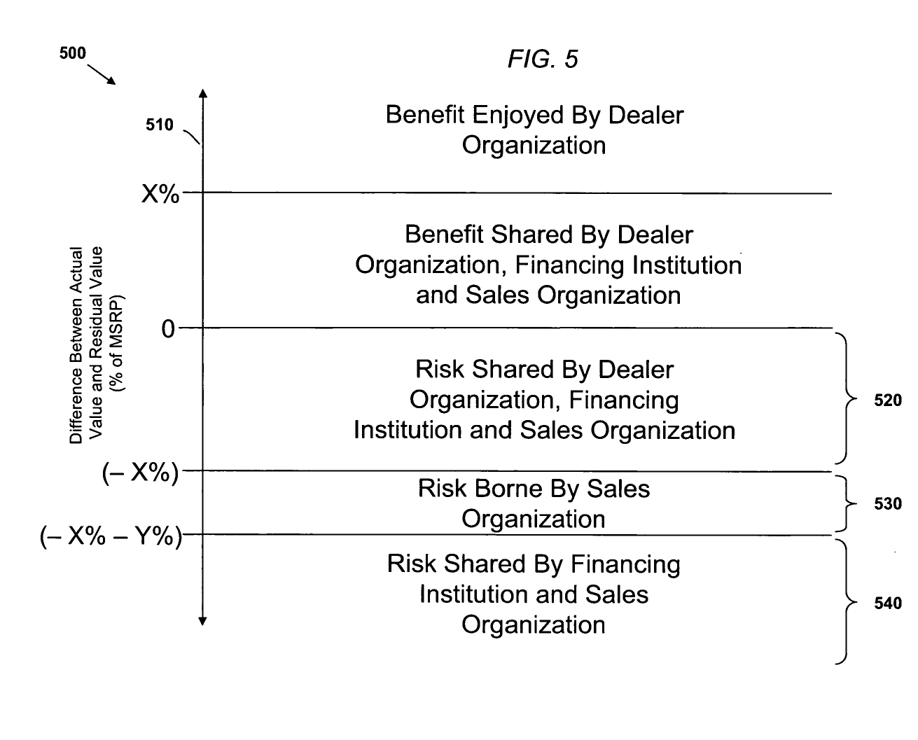

Referring now to FIG. 5, depicted is another embodiment of a graph 500 of how residual value risk may be allocated amongst a dealer organization (e.g., dealer organization 120 of FIG. 1), a financing institution (e.g., financing institution 140 of FIG. 1) and a sales organization (e.g., sales organization 150 of FIG. 1). As with FIGS. 3A-3B, FIG. 5 plots along axis 510 the difference, or gap, between the vehicle's actual value against the vehicle's residual value, expressed as a percentage of the vehicle's MSRP. In one embodiment, this percentage represents the amount calculated at block 230 of FIG. 2.

When the value of axis 510 is between 0 and −X %, the vehicle is in gap 520 and the risk (or financial burden) may be shared between the dealer organization, the financial institution and the sales organization according to some predetermined ratio. By way of a non-limiting example, the ratio may be 3:2:1 as between the dealer organization, financial institution and sales organization, respectively.

When the value of axis 510 is lower than −X %, but not lower than −X % −Y %, the risk (or financial burden) associated with gap 530 is depicted as being borne exclusively by the sales organization. Similarly, when the value of axis 510 is lower than −X % −Y %, the risk (or financial burden) associated with gap 540 may be again shared, but this time between the financing institution and the sales organization. In this fashion, the total amount of residual risk may be selectively allocated between the dealer organization, financing institution and sales organization such that all interested parties are incentivized to not only obtain a good market value for the vehicle at lease maturity, but also to ensure that the residual value set at contract time is as accurate as possible.

While the invention has been described in connection with various embodiments, it should be understood that the invention is capable of further modifications. This application is intended to cover any variations, uses or adaptation of the invention following, in general, the principles of the invention, and including such departures from the present disclosure as come within the known and customary practice within the art to which the invention pertains.

What is claimed is:

1. A method for allocating residual value risk for a vehicle leased to a consumer comprising the acts of:
setting a residual value for the vehicle to be applicable at a predetermined maturity date;
determining an actual value for the vehicle at said predetermined maturity date;
calculating a difference between the residual value and the actual value;
allocating a first portion of the difference to a dealer organization;
allocating a second portion of the difference to a manufacturer group, wherein the manufacturer group includes a financing institution which financed the vehicle for the consumer, and a sales organization which sold the vehicle to the dealer organization.

2. The method of claim 1, wherein calculating the difference further comprises the act of representing the difference as a percentage of a manufacturer suggested retail price for the vehicle.

3. The method of claim 1, wherein allocating the first portion and second portion comprises allocating the first portion and second portion up to a predetermined amount for said difference.

4. The method of claim 3, wherein the first portion and the second portion are equal up to the predetermined amount.

5. The method of claim 3, further comprising the act of allocating a third portion of the difference above the predetermined amount to one of the dealer organization and manufacturer group.

6. The method of claim 1, wherein allocating the second portion comprises allocating a first percentage of the second portion to the financing institution and allocating a second percentage of the second portion to the sales organization.

7. The method of claim 1, wherein the first portion and second portion cumulatively correspond to financial obligations equal to the difference when the difference is a negative value.

8. The method of claim 1, wherein the first portion and second portion cumulatively correspond to a financial benefit equal to the difference when the difference is a positive value.

9. A method for allocating residual value risk comprising the acts of:
determining a residual value for a leased vehicle;
determining an actual value for the vehicle;
calculating a difference between the residual value and the actual value;
allocating a first portion of the difference to a dealer organization that is to reclaim said leased vehicle;
allocating a second portion of the difference a financing institution which financed the vehicle for the consumer; and
allocating a third portion of the difference to a sales organization which sold the vehicle to the dealer organization.

10. The method of claim 9, wherein calculating the difference further comprises the act of representing the difference as a percentage of a manufacturer suggested retail price for the vehicle.

11. The method of claim 9, wherein allocating the first portion, second portion and third portion comprises allocating the first portion, second portion and third portion up to a predetermined amount for said difference.

12. The method of claim 11, wherein the first portion, second portion and third portion are allocated up to the predetermined amount according to a ratio of 3:2:1, respectively.

13. The method of claim 11, further comprising the act of allocating a fourth portion of the difference above the predetermined amount to one of the dealer organization, financing institution and sales organization.

14. The method of claim 9, wherein the first portion, second portion and third portion cumulatively correspond to a financial obligation equal to the difference when the difference is a negative value.

15. The method of claim 9, wherein the first portion, second portion and third portion cumulatively correspond to a financial benefit equal to the difference when the difference is a positive value.

16. A computer program product, comprising:
a processor readable medium having processor executable code embodied therein to allocate residual value risk for a vehicle leased to a consumer, the processor readable medium having:
processor executable program code to set a residual value for the vehicle to be applicable at a predetermined maturity date;
processor executable program code to determine an actual value for the vehicle at said predetermined maturity date;
processor executable program code to calculate a difference between the residual value and the actual value;
processor executable program code to allocate a first portion of the difference to a dealer organization; and
processor executable program code to allocate a second portion of the difference to a manufacturer group, wherein the manufacturer group includes a financing institution which financed the vehicle for the consumer, and a sales organization which sold the vehicle to the dealer organization.

17. The computer program product of claim 16, wherein the processor executable program code to calculate the difference further comprises processor executable program code to represent the difference as a percentage of a manufacturer suggested retail price for the vehicle.

18. The computer program product of claim 16, wherein the processor executable program codes to allocate the first portion and second portion comprise corresponding processor executable program codes to allocate the first portion and second portion up to a predetermined amount for said difference.

19. The computer program product of claim 18, wherein the first portion and the second portion are equal up to the predetermined amount.

20. The computer program product of claim 18, further comprising processor executable program code to allocate a third portion of the difference above the predetermined amount to one of the dealer organization and manufacturer group.

21. The computer program product of claim 16, wherein the processor executable program code to allocate the second portion comprises processor executable program code to allocate a first percentage of the second portion to the financing institution and allocate a second percentage of the second portion to the sales organization.

22. The computer program product of claim 16, wherein the first portion and second portion cumulatively correspond to financial obligations equal to the difference when the difference is a negative value.

23. The computer program product of claim 16, wherein the first portion and second portion cumulatively correspond to a financial benefit equal to the difference when the difference is a positive value.
